(19) United States
(12) Patent Application Publication
(10) Pub. No.: US 2015/0283907 A1
(43) Pub. Date: Oct. 8, 2015

(54) POWER BOOST CIRCUIT

(71) Applicant: Caterpillar Inc., Peoria, IL (US)

(72) Inventor: Brian J. Huber, Kane County, IL (US)

(73) Assignee: Caterpillar Inc., Peoria, IL (US)

(21) Appl. No.: 14/245,019

(22) Filed: Apr. 4, 2014

(51) Int. Cl. B60L 5/42; B60L 11/18

(52) U.S. Cl. CPC B60L 5/42; B60L 11/1801; B60L 11/1816

(57) ABSTRACT

The power boost circuit is disclosed. The power boost circuit includes a controller, one or more switches and a capacitor bank. The capacitor bank is connected to an overhead trolley line for charging the capacitor bank to an operating voltage of the overhead trolley line. The capacitor bank is then connected in between the trolley line and an electric drive machine such that the capacitor bank discharging results in boosting of the operating voltage of the electrical trolley line. This boosted voltage is then used as a driving voltage for the electric drive machine.

### TECHNICAL FIELD

The present disclosure relates to a circuit, system and method for boosting power; and more particularly, to a circuit, system and method for boosting power generated by a trolley line for driving an electric drive machine.

### BACKGROUND

Electric drive machines, such as, an electric drive mine truck, are typically powered using a trolley line. Based on different factors, such as, payload on the mine trucks, terrain of the mines, and the like, different mine trucks may have different power requirements and hence, need different values of operating voltages. Mine trucks are typically powered through a trolley line having a fixed voltage value. A fixed voltage trolley line cannot provide for powering mine trucks that have a voltage requirement greater than the trolley line voltage. For example, a high voltage mine truck cannot operate on a medium voltage trolley line.

U.S. Pat. No. 6,643,360 describes a circuit arrangement for boosting current rating. A low voltage high-current direct current (DC) power source is connected in series with a high voltage low current DC source. The series connection is made to operate under full power by using another source that commutates the load current and allows the high voltage low current source to be reconfigured to a parallel connection from a series connection and doubles the current rating.

### SUMMARY OF THE DISCLOSURE

In one aspect of the disclosure, a power boost circuit is disclosed. The power boost circuit comprises an electrical trolley line input providing a first voltage and an electrical drive voltage output providing a second voltage. The power boost circuit further comprises a capacitor bank connected to the electrical trolley line input and the electrical drive output. The power boost circuit further comprises a controller that is configured to alternatingly electrically connect the capacitor bank to the electrical trolley line input to charge the capacitor bank to the first voltage and electrically disconnect the electrical trolley line input from the capacitor bank after charging is complete and sequentially connect the capacitor bank to the electrical drive output to provide the second voltage, wherein the second voltage is greater than the first voltage.

In another aspect of the disclosure, a method for boosting power is disclosed. The method comprises electrically connecting a capacitor bank to an electrical trolley line input operating at a first voltage to charge the capacitor bank to the first voltage. The method further comprises electrically disconnecting the electrical trolley line input from the capacitor bank after charging is complete and sequentially connecting the capacitor bank to an electrical drive to provide a second voltage, wherein the second voltage is greater than the first voltage.

In yet another aspect of the disclosure, a system is disclosed. The system comprises a machine, a capacitor bank and a controller. The controller is configured to alternatively electrically connect a capacitor bank to an electrical trolley line input operating at a first voltage to charge the capacitor bank to the first voltage. The controller is further configured to electrically disconnect the electrical trolley line input from the capacitor bank after charging is complete and sequentially connect the capacitor bank to an electrical drive output to provide a second voltage, wherein the second voltage is greater than the first voltage.

Other features and aspects of this disclosure will be apparent from the following description and the accompanying drawings.

### BRIEF DESCRIPTION OF THE DRAWINGS

FIG. 1 depicts a front view of an exemplary machine that can be driven using a power boost circuit, in accordance with an embodiment of the present disclosure;

FIG. 2(A) depicts exemplary electrical connections of the power boost circuit, in accordance with an embodiment of the present disclosure; and

FIG. 2(B) depicts an alternative configuration of the power boost circuit, in accordance with an embodiment of the present disclosure.

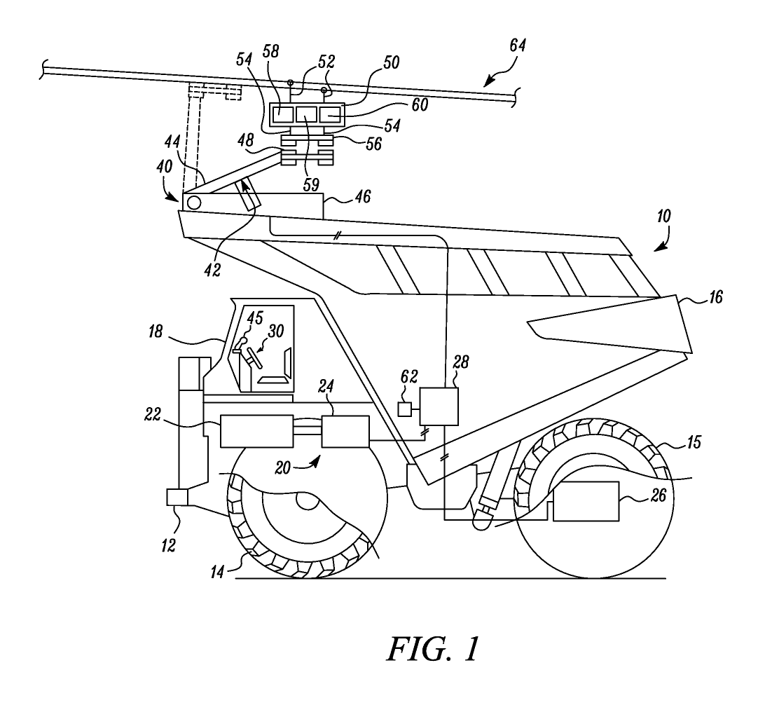

### DETAILED DESCRIPTION

Wherever possible, the same reference numbers will be used throughout the drawings to refer to the same or the like parts. FIG. 1 illustrates a trolley-assist capable mining truck 10, according to one embodiment. The mining truck 10 may include a frame 12 having a front set of ground engaging elements 14 and a back set of ground engaging elements 15, coupled with the frame 12. In the illustrated embodiment, the ground engaging elements 14 include two front wheels, and the ground engaging elements 15 include a set of four back wheels, although the present disclosure is not thereby limited. A bed 16 is coupled with the frame 12, and may be tilted between a lowered position, as shown, and a lifted position, to dump material from the bed 16 in a conventional manner.

The mining truck 10 may further include a propulsion system 20, of which the ground engaging elements 14 and 15 are a part, and including an engine 22, such as a compression ignition internal combustion engine, and a generator 24 powered via the engine 22. The propulsion system 20 may further include one or more electric propulsion motors coupled with the ground engaging elements 15. The propulsion system 20 may still further include a pantograph 40 configured to electrically connect with an overhead trolley line 64.

As noted above, the mining truck 10 may be trolley-assist capable. Those skilled in the art will be familiar with mining trucks configured to operate via electric power from an overhead trolley line in certain instances, such as when carrying a load of material on an uphill grade. In one practical implementation strategy, the mining truck 10 may transition between a first operating mode where the propulsion system 20 is receiving power entirely from the overhead trolley line 64, and a second operating mode where power is received from the overhead trolley line 64 through a power boost circuit 50, hereinafter referred to as circuit 50. Further, for the second operating mode, the circuit 50 is connected to the overhead trolley line 64 through an electrical trolley line input 52, hereinafter referred to as input 52. On the mining truck 10 end, the circuit 50 may be connected to the pantograph 40 through an electrical drive output 54, hereinafter referred to as output 54, using output contacts 56. Embodiments are also contemplated in which a blend of electrical power from the overhead trolley line 64 and the engine 22/the generator 24 is used in the first operating mode, or where mechanical power is provided from the engine 22 to the ground engaging elements 15 and/or the ground engaging elements 14 in either mode.

A cab 18 may be mounted to the frame 12, and an operator control station 30 may be positioned within the cab 18. The operator control station 30 may include a variety of operator input devices for controlling and monitoring operation of the mining truck 10. Among these may be a switch 45, such as a push-button switch, control lever or other operator manipulable mechanism, which enables an operator to adjust the mining truck 10, and in particular, the propulsion system 20, between an automated mode and a fully manual or partially manual mode. In an automated mode, raising and lowering of the pantograph 40 may be controlled without the need for any manual action by the operator. Other features of the propulsion system 20, such as the engine 22 and the generator 24 may be autonomously controlled to transition the mining truck 10 between the first operating mode and the second operating mode.

A position of a contact switch 48 may determine whether the mining truck 10 is operated in first operating mode or the second operating mode, and also whether pantograph control is automated or given to the operator. Further, an electronic control unit 62 may be in communication with power electronics 28 and operable to configure the power electronics 28 appropriately for receiving electrical power from the overhead trolley line 64, or alternatively from the generator 24, or both. The power electronics 28 may supply electrical power, regardless of the source, to a propulsion motor 26 in a known manner.

The pantograph 40 may further include a linkage 44 coupled with a base 46 configured to mount to the frame 12, for instance at a front of the bed 16. The pantograph 40 may be adjustable by way of an actuating mechanism 42 between the first operating mode for contacting the overhead trolley line 64, and the second operating mode for connecting the circuit 50 in between the overhead trolley line 64 and the mining truck 10. The pantograph 40 may include the contact switch 48, configured to electrically connect the overhead trolley line 64 with the power electronics 28, in the first operating mode, as alluded to above. The contact switch 48 may further be configured to connect the pantograph 40 to the output contacts 56 in the second operating mode.

As shown, the circuit 50 may be connected between the overhead trolley line 64 and the mining truck 10. The circuit may be configured to boost power generated by the overhead trolley line 64 such that the boosted power is fed to the mining truck 10 using the pantograph 40. The circuit may be connected to the overhead trolley line 64 through the input 52. Further, the circuit may be connected to the pantograph 40 through the output 54 using the output contacts 56.

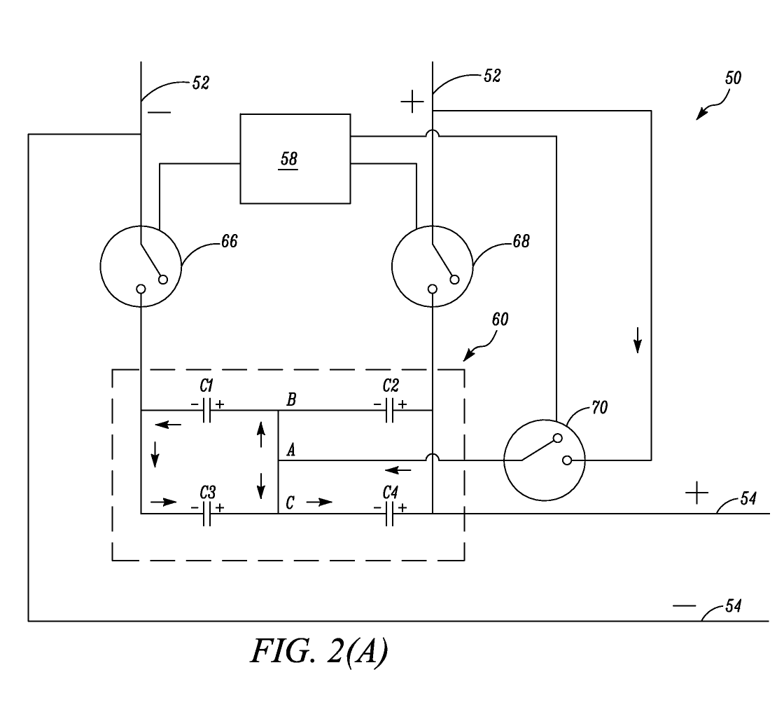

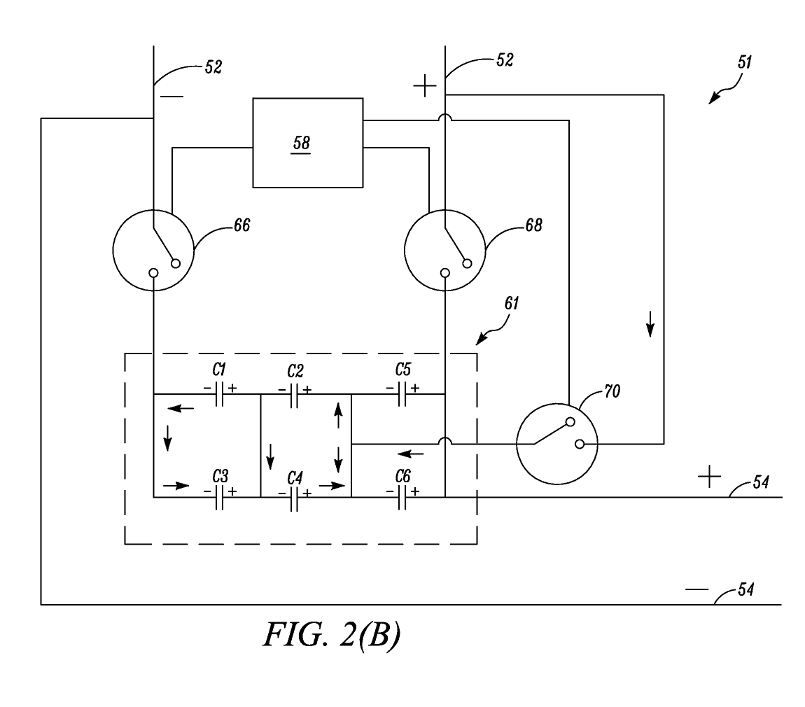

The circuit 50 may include a controller 58, one or more switches 59 and a capacitor bank 60 (exemplary implementations of which are shown in FIGS. 2(A) and 2(B)). The controller 58 may be configured to control the one or more switches 59 in order to connect the overhead trolley line 64 to the mining truck 10 through the capacitor bank 60 for alternatingly charging and discharging the capacitor bank 60. For charging the capacitor bank 60 to an operating voltage of the overhead trolley line 64, the controller 58 arranges the one or more switches 59 in a manner that the capacitor bank 60 is connected to the overhead trolley line 64 through the input 52. In an embodiment, during discharging, the capacitor bank 60 is connected such that voltage through the output 54 is greater than the operating voltage of the overhead trolley line 64. This additional voltage is provided in the circuit 50 during discharging. This boosted voltage may then be fed to the mining truck 10 through the output 54. Thus, a power boost circuit, such as the circuit 50, may enable high voltage mining trucks to operate on low voltage trolley lines without the need of separate infrastructures. Further implementation details and electrical connections of the circuit 50 are described in conjunction with FIG. 2(A).

FIG. 2(A) depicts electrical connections of the circuit 50, in accordance with embodiments of the present disclosure. In one embodiment, the circuit 50 may be a part of a standalone system connected between an electrical trolley line and a machine for boosting a drive voltage for driving the machine. In another implementation, the circuit 50 may be implemented within the machine for boosting the drive voltage available to the machine.

As illustrated in the figure, the circuit 50 includes the input 52, electrically connected to the electrical trolley line providing the first voltage. In an example, the first voltage provided by the electrical trolley line is 1500 volts. In typical arrangements for driving an electric drive machine, such as the mining truck 10, the electrical trolley line may be the overhead trolley line 64, as depicted in FIG. 1. In an embodiment of the present disclosure, the circuit 50 is implemented in such a manner that it is electrically connected between the overhead trolley line 64 and the mining truck 10.

As depicted, the circuit 50 further includes the capacitor bank 60, the controller 58, and the one or more switches 59. The one or more switches 59 may include input switches 66, 68 and an output switch 70. In one embodiment, the capacitor bank 60 may include two stages of capacitors connected in parallel with each stage having two capacitors connected in series. In the example shown in FIG. 2(A), capacitors C1 and C2 are connected in series. Similarly, capacitors C3 and C4 are also connected in series. Further, a branch formed by the capacitors C1 and C2 is in parallel to a branch formed by the capacitors C3 and C4. In another embodiment, only three capacitors may be used. In such an embodiment, the three capacitors may be connected in series and one of the three capacitors may be connected to the trolley line through the output switch 70. In yet another embodiment, three stages, each having two capacitors connected in series, may be used. Such alternative embodiments may be implemented for obtaining different values of drive voltages.

As shown in FIG. 2(A), the capacitor bank 60 is connected to the input 52 through the switches 66, 68. The input switch 66 connects the positive terminal of the input 52 to the capacitor bank 204 and the input switch 68 connects the negative terminal of the input 52 to the capacitor bank 60. Further, the positive terminal and the negative terminal of the input 52 are connected to the positive line and the negative line of the trolley line respectively.

In operation, the capacitor bank 60 undergoes a charging cycle for storing energy and a discharging cycle for dissipating the stored energy. In an embodiment, the charging and the discharging cycles of the capacitors in the capacitor bank 60 may be periodic where the period may be predetermined based on different requirements. For charging the capacitors, the capacitor bank 60 is connected to the input 52 by closing the switches 66, 68 and keeping the output switch 70 open. In an example, the switches 59 may be controlled by the controller 58 such that the capacitor bank 60 may be alternatingly connected to the input 52 for charging of the capacitor bank 60.

During charging, current flows into the capacitor bank 60, from the input 52 for charging the capacitor bank 60 to the first voltage. For the sake of better understating of the charging and the discharging cycles of the capacitor bank 60, an exemplary value of the input voltage is assumed to be V₁ volts. Further, it is assumed that value of capacitance for each of the capacitors, i.e., the capacitors C1, C2, C3, and C4 is C Farad and the voltages on the capacitors are V_{C1}, V_{C2}, V_{C3} and V_{C4} respectively. It would be understood by a person skilled in the art, that alternative values of capacitances may be used for obtaining different drive voltages.

As current flows through the capacitor bank 60, each capacitor gets charged to a voltage 0.5V₁ due to equal values of capacitances, i.e. C Farad. The polarities of the charged capacitors C1, C2, C3 and C4 are as depicted in the figure. Once the capacitors are charged to their respective capacities, the controller 58 opens the input switches 66, 68, thus disconnecting the capacitor bank 60 from the input 52 for the discharging cycle.

During the discharging cycle, the controller 58 closes the output switch 70. Closing of the output switch 70 effectively connects the capacitor bank 60 to the input 52 such that current flows through a node A and the capacitors C1 and C3 are connected in series while the capacitors C2 and C4 are connected in parallel. As the capacitors C1 and C3 are charged to a voltage 0.5V₁ in opposite polarities and are connected in series, they cancel each other out, thus making the effective voltage of the branch zero. This is as shown by the below equation:

V_{C1}+V_{C3}=0.5V₁+(−0.5V₁)=0 Volts Equation (1)

### Where:

V_{C1} is voltage on the capacitor C1;
V_{C3} is voltage on the capacitor C3; and
V₁ is the first voltage.

Further, current flowing through a node C in the capacitor C4 and through a node B in the capacitor C3 effectively results in a parallel connection between the capacitors C3 and C4 with equivalent voltage as 0.5V1. This is as shown by the below equation:

V_{C2}=V_{C4}=0.5V₁ Volts Equation (2)

### Where:

V_{C2} is voltage on the capacitor C2;
V_{C4} is voltage on the capacitor C4; and
V₁ is the first voltage.

Thus, resultant voltage (Vₒᵤₜ) of the circuit 50 during the discharging cycle sums up to 1.5V₁. This is as shown by the below equation:

Vₒᵤₜ=V₁+(0.5×V₁)=1.5V₁ Volts Equation (3)

### Where:

Vₒᵤₜ is the resultant voltage; and
V₁ is the first voltage.
   Referring back to the above example of the first voltage being 1500 volts, the resultant voltage sums up to 2250 volts. Current flowing through the capacitor bank 60 during the discharging cycle is as depicted by the arrows in FIG. 2(A).

In an implementation, the boosted voltage may be used as the drive voltage of the mining truck 10 through the output 54. The negative terminal of the output 54 is a direct feed from the negative terminal of the input 52. Further, the positive terminal of the input 52 is connected to the capacitor bank 60 via the output switch 70 and then fed into a positive terminal of the output 54. Therefore, due to connection of the circuit 50 in between the trolley line and the mining truck 10, an effective voltage of 1.5V₁ is available to drive the mining truck 10, instead of the original operating voltage V₁ (as shown by the Equation (3) above). Hence, using the circuit 50, high voltage requirements for driving machines may be met by medium voltage trolley lines. This reduces the cost of installation and maintenance of separate trolley lines for different machines.

In various embodiments, other configurations of the capacitor bank 60 may be used for obtaining different boost voltages. For example, three or more stages of capacitors may be connected in parallel to each other. Each stage may have two capacitors connected in a series connection. In another example, only a single stage having two capacitors connected in series may be used.

Further, in alternate implementations, more than three capacitors may be used in series in each stage. One such configuration of a capacitor bank 61 connected in a circuit 51, is illustrated in FIG. 2(B). For the sake of better understating of the charging and the discharging cycles of the capacitor bank 61, an exemplary value of the input voltage is assumed to be V₁ volts. Further, it is assumed that value of capacitance for each of the capacitors, i.e., capacitors C1, C2, C3, C4, C5 and C6 is C Farad. It would be understood by a person skilled in the art, that alternative values of capacitances may be used for obtaining different drive voltages.

In the illustrated configuration, the capacitor bank 61 includes two stages of capacitors in parallel, each stage having three capacitors in series. During the charging cycle, the controller 58 closes the input switches 66, 68 and the capacitor bank 61 is charged through the input 52, to the first voltage, i.e. V₁. Once the capacitors are charged to their capacities (i.e., C Farad), a discharging cycle starts.

For the discharging cycle, the controller 58 opens the input switches 66, 68 and closes the output switch 70. Closing the output switch 70 effectively connects the capacitors in a way that the equivalent voltage of the capacitor bank 61 is V₁/3 volts. Thus resultant voltage of the circuit 51 thus becomes 4V₁/3 volts which may be fed to the mining truck 10 through the output 54. For example, if a trolley line voltage is 1500 volts, a maximum drive voltage of 2000 volts may be fed to a machine using the above configuration. Current flowing through the capacitor bank 61 during the discharging cycle is as depicted by the arrows in FIG. 2(B). In various alternate configurations, more than two stages of capacitors in parallel may also be used for varying power requirements.

### INDUSTRIAL APPLICABILITY

The present disclosure relates to the driving of the mining truck 10 using the overhead trolley line 64 using the circuit 50, 51. The circuit 50, 51 may seamlessly enable high voltage mining trucks, such as the mining truck 10, to operate on medium voltage trolley line, such as the overhead trolley line 64. This may in turn cut down on installation costs for separate trolley lines for mining trucks having different voltage requirements.

The circuit 50, 51 includes the capacitor bank 60, 61 that is connected in between the overhead trolley line 64 and the mining truck 10. The capacitor bank 60, 61 is charged to the operating voltage of the overhead trolley line 64 using the input 52. The capacitor bank 60, 61 is then discharged into the circuit 50, 51 such that the voltage of the overhead trolley line 64 is boosted and the boosted voltage is used to drive the mining truck 10 through the output 54.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A power boost circuit comprising:
an electrical trolley line input providing a first voltage;
an electrical drive output providing a second voltage;
a capacitor bank connected to the electrical trolley line input and the electrical drive output; and
a controller configured to alternatingly:
electrically connect the capacitor bank to the electrical trolley line input to charge the capacitor bank to the first voltage; and
electrically disconnect the electrical trolley line input from the capacitor bank after charging is complete and sequentially connect the capacitor bank to the electrical drive output to provide the second voltage, wherein the second voltage is greater than the first voltage.

2. The power boost circuit of claim 1 further comprising:
a first switch and a second switch, wherein the first switch is electrically connected to a negative terminal of the electrical trolley line input and the second switch is electrically connected to a positive terminal of the electrical trolley line input.

3. The power boost circuit of claim 2, wherein the controller is further configured to close the first switch and the second switch for charging the capacitor bank.

4. The power boost circuit of claim 1 further comprising:
a third switch and wherein the controller is further configured to close the third switch for connecting the electrical trolley line input and the capacitor bank to the electrical drive output.

5. The power boost circuit of claim 1, wherein with the first and second switches open and the third switch closed the positive terminal of the electrical trolley line input and the power discharged by the capacitor bank is electrically coupled to a positive terminal of the electrical drive output.

6. The power boost circuit of claim 1, wherein the capacitor bank comprises one or more groups of capacitors in a parallel connection.

7. The power boost circuit of claim 1, wherein each of the one or more groups of capacitors comprises two or more capacitors in a series connection.

8. The power boost circuit of claim 1, wherein the electrical drive output is used to supply an electric drive mine truck.

9. A method comprising:
electrically connecting a capacitor bank to an electrical trolley line input operating at a first voltage to charge the capacitor bank to the first voltage; and
electrically disconnecting the electrical trolley line input from the capacitor bank after charging is complete and sequentially connecting the capacitor bank to an electrical drive output to provide a second voltage, wherein the second voltage is greater than the first voltage.

10. The method of claim 8 further comprising:
electrically connecting a first switch to a negative terminal of the input trolley line and electrically connecting a second switch to a positive terminal of the input trolley line.

11. The method of claim 8 further comprising:
closing the first switch and the second switch for charging the capacitor bank.

12. The method of claim 8 further comprising:
closing a third switch for connecting the input trolley line to the machine.

13. The method of claim 8 further comprising:
electrically connecting one or more groups of capacitors in a parallel connection.

14. The method of claim 12, wherein each of the one or more groups of capacitors comprises two or more capacitors in a series connection.

15. The method of claim 12, wherein with the first and second switches open and the third switch closed the positive terminal of the electrical trolley line input and the power discharged by the capacitor bank is electrically coupled to a positive terminal of the electrical drive output.

16. A system comprising:
a machine;
a capacitor bank; and
a controller configured to alternatively:
electrically connect a capacitor bank to an electrical trolley line input operating at a first voltage to charge the capacitor bank to the first voltage; and
electrically disconnect the electrical trolley line input from the capacitor bank after charging is complete and sequentially connect the capacitor bank to an electrical drive output to provide a second voltage, wherein the second voltage is greater than the first voltage.
